(19) United States
(12) Patent Application Publication
(10) Pub. No.: US 2026/0185918 A1
(43) Pub. Date: Jul. 2, 2026

(54) METHOD FOR SIMULTANEOUS MEASUREMENT OF VELOCITY AND TEMPERATURE FIELDS BASED ON TEMPERATURE-SENSITIVE PHOSPHORESCENT PARTICLES

(71) Applicant: Taiyuan University of Technology, Jinzhong (CN)

(72) Inventors: Junfei Ding, Jinzhong (CN); Jialong ZHANG, Jinzhong (CN); Shihao LI, Jinzhong (CN); Jingxiang QU, Jinzhong (CN)

(21) Appl. No.: 19/435,543

(22) Filed: Dec. 29, 2025

(30) Foreign Application Priority Data
Dec. 30, 2024 (CN) 202411968463.7

(51) Int. Cl. G01N 15/075; G01K 11/12; G01N 15/00

(52) U.S. Cl. CPC G01N 15/075; G01K 11/12; G01N 2015/0003

(57) ABSTRACT

A method for simultaneous measurement of velocity and temperature fields based on temperature-sensitive phosphorescent particles includes the steps of: establishing a lifetime-temperature curve by measuring lifetimes of temperature-sensitive phosphorescent particles; capturing time-sequential images of the temperature-sensitive phosphorescent particles; processing the time-sequential images via three-view separation to obtain processed images; performing three-dimensional (3D) reconstruction and trajectory fitting on the processed images to obtain a 3D velocity field; acquiring red full-resolution images of the temperature-sensitive phosphorescent particles after illumination; calculating intensities of the temperature-sensitive phosphorescent particles from the red full-resolution images, and determining a phosphorescence lifetime based on the intensities of the particles; determining a 3D temperature field based on the lifetime-temperature curve and the phosphorescence lifetime; and fusing the 3D velocity field and the 3D temperature field to obtain a 3D velocity-temperature field. Enhanced stability in velocity field reconstruction and improved accuracy in temperature measurement are achieved.

### CROSS-REFERENCE TO RELATED APPLICATION

This application claims priority of Chinese Patent Application No. 202411968463.7, filed on Dec. 30, 2024, the entire contents of which are incorporated herein by reference.

### TECHNICAL FIELD

The present disclosure relates to the technical field of flow field observation, and particularly to a method for simultaneous measurement of velocity and temperature fields based on temperature-sensitive phosphorescent particles.

### BACKGROUND

Flow field measurement is widely used in various fields. In the related art, techniques such as particle image velocimetry (PIV) or particle tracking velocimetry (PTV) are commonly employed to acquire information on fluid velocity. The measurement of the temperature field in a three-dimensional (3D) flow is typically conducted separately using tunable diode laser absorption spectroscopy (TDLAS) technology.

However, measurements of velocity and temperature fields are predominantly conducted in separate steps, which precludes the simultaneous acquisition of parameters in a flow field, thereby introducing spatial and temporal errors into the measurement data and compromising the accuracy of the research. Furthermore, existing techniques capable of simultaneous measurement suffer from drawbacks such as overly complex optical setups and insufficient spatial and temporal resolution. Therefore, it is highly necessary to develop a method for simultaneous measurement of velocity and temperature fields based on temperature-sensitive phosphorescent particles.

### SUMMARY

An objective of the present disclosure is to provide a method for simultaneous measurement of velocity and temperature fields based on temperature-sensitive phosphorescent particles. By integrating a trichromatic-mask single-color camera and lifetime-based thermographic phosphor thermometry, enhanced stability in 3D velocity field reconstruction and improved accuracy in temperature measurement are achieved.

To realize the above objective, the present disclosure provides the following technical solutions:
a method for simultaneous measurement of velocity and temperature fields based on temperature-sensitive phosphorescent particles includes the steps of:
establishing a lifetime-temperature curve by measuring lifetimes of the temperature-sensitive phosphorescent particles;
capturing time-sequential images of the temperature-sensitive phosphorescent particles under illumination;
processing the time-sequential images via three-view separation to obtain processed images;
performing 3D reconstruction and trajectory fitting on the processed images to obtain a 3D velocity field;
acquiring red full-resolution images of the temperature-sensitive phosphorescent particles following the illumination;
calculating intensities of the temperature-sensitive phosphorescent particles in the red full-resolution images using the 3D velocity field to determine a phosphorescence lifetime;
determining a 3D temperature field based on the lifetime-temperature curve and the phosphorescence lifetime; and
fusing the 3D velocity field and the 3D temperature field to obtain a 3D velocity-temperature field.

Alternatively, the establishing a lifetime-temperature curve by measuring lifetimes of the temperature-sensitive phosphorescent particles includes the steps of determining phosphorescence decay constants of the temperature-sensitive phosphorescent particles at different temperatures according to the phosphorescence decay equation, and establishing the lifetime-temperature curve based on a variation pattern of the decay constants as a function of temperature.

Alternatively, the processing the time-sequential images via three-view separation to obtain processed images includes the steps of:
extracting viewing-angle information from the time-sequential images via red, green, and blue color channels to obtain raw images;
interpolating the raw images to obtain interpolated images; and
correcting color crosstalk in the interpolated images to obtain the processed images.

Alternatively, the processing the time-sequential images via three-view separation to obtain processed images further includes the steps of: performing volume calibration on the interpolated images to obtain a transformation relationship between 2D image coordinates and 3D world coordinates, with the transformation relationship expressed as:

$$[ \begin{matrix}{x}_{j} \\ {y}_{j} \\ 1\end{matrix} ] = [ \begin{matrix}{a}_{11} {a}_{12} {a}_{13} {a}_{14} \\ {a}_{21} {a}_{22} {a}_{23} {a}_{24} \\ {a}_{31} {a}_{32} {a}_{33} {a}_{34}\end{matrix} ] \cdot [ \begin{matrix}{X}_{j} \\ {Y}_{j} \\ {Z}_{j} \\ 1\end{matrix} ] ,$$

where xⱼ and yⱼ represent horizontal and vertical coordinates in an image coordinate system, respectively; Xⱼ, Yⱼ, and Zⱼ are 3D coordinates in a world coordinate system; and a₁₁, a₁₂, . . . , and a₃₄ are coefficients constituting a matrix.

Alternatively, the performing 3D reconstruction and trajectory fitting on the processed images to obtain a 3D velocity field includes the steps of:
obtaining a 3D particle distribution of a first portion of the processed images via triangulation;
performing a particle position prediction on a second portion of the processed images using the 3D particle distribution and a Wiener filter, to obtain a prediction result;
applying a jitter adjustment to the prediction result to obtain particle trajectories; and
deriving the 3D velocity field from a 3D distribution of the particle trajectories.

Alternatively, the applying a jitter adjustment to the prediction result to obtain particle trajectories includes the steps of:
performing a coordinate shift on 3D world coordinates of the prediction result to obtain shifted coordinates;
obtaining a residual-displacement relationship curve from residuals between reprojection images of the shifted coordinates and the processed images; and
re-predicting particle positions by applying the residual-displacement relationship curve to the prediction result to obtain the particle trajectories.

Alternatively, the calculating intensities of the temperature-sensitive phosphorescent particles in the red full-resolution images using the 3D velocity field to determine a phosphorescence lifetime includes the steps of:
performing two-dimensional (2D) particle tracking on the red full-resolution images using the 3D velocity field to obtain a red particle distribution; and
calculating the phosphorescence lifetime from the red particle distribution and a phosphorescence decay equation.

The present disclosure provides a method for simultaneous measurement of velocity and temperature fields based on temperature-sensitive phosphorescent particles, including the steps of: establishing a lifetime-temperature curve by measuring lifetimes of the temperature-sensitive phosphorescent particles; capturing time-sequential images of the temperature-sensitive phosphorescent particles under illumination; processing the time-sequential images via three-view separation to obtain processed images; performing 3D reconstruction and trajectory fitting on the processed images to obtain a 3D velocity field; acquiring red full-resolution images of the temperature-sensitive phosphorescent particles following the illumination; calculating intensities of the temperature-sensitive phosphorescent particles in the red full-resolution images using the 3D velocity field to determine a phosphorescence lifetime; determining a 3D temperature field based on the lifetime-temperature curve and the phosphorescence lifetime; and fusing the 3D velocity field and the 3D temperature field to obtain a 3D velocity-temperature field.

### BRIEF DESCRIPTION OF THE DRAWINGS

To more clearly illustrate the technical solutions in the embodiments of the present disclosure or the related art, the accompanying drawings required for describing the embodiments are briefly introduced below. Obviously, the drawings in the following description represent merely some embodiments of the present disclosure. Those of ordinary skill in the art may obtain other drawings based on these provided herein without creative effort.

FIG. 1 shows a flow chart of a method for simultaneous measurement of velocity and temperature fields according to the present disclosure.

FIG. 2 shows a lifetime-temperature curve according to the present disclosure.

FIG. 3 shows a flow chart of three-view separation according to the present disclosure.

FIG. 4 shows a schematic diagram of a 3D velocity-temperature field according to the present disclosure.

### DETAILED DESCRIPTION

The technical solutions in the embodiments of the present disclosure are described below clearly and completely with reference to the accompanying drawings. Obviously, the described embodiments are merely some, but not all, of the embodiments of the present disclosure. Based on the embodiments of the present disclosure, all other embodiments obtained by those of ordinary skill in the art without creative effort fall within the scope of protection of the present disclosure.

To make the aforementioned objectives, features, and advantages of the present disclosure more apparent and comprehensible, the present disclosure is further described in detail below with reference to the drawings and specific implementations.

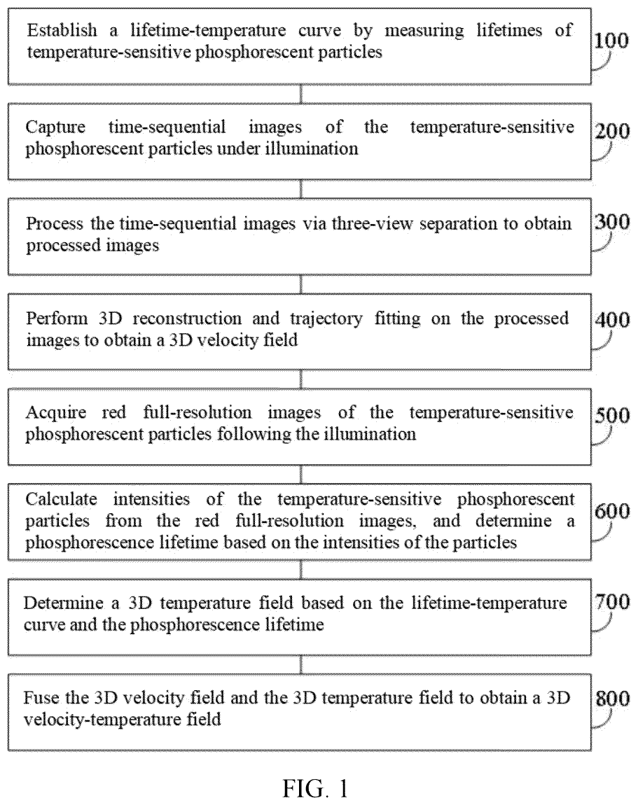

Referring to FIG. 1, an embodiment of the present disclosure provides a method for simultaneous measurement of velocity and temperature fields based on temperature-sensitive phosphorescent particles, including the following steps:

In step 100, a lifetime-temperature curve is established by measuring lifetimes of the temperature-sensitive phosphorescent particles.

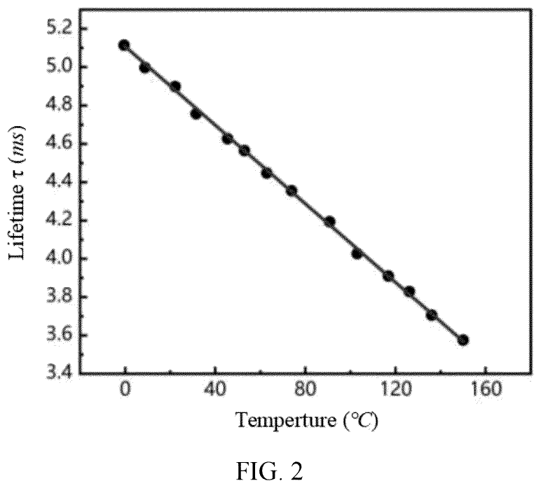

Specifically, a constant-temperature chamber is heated to the lowest preset temperature. The temperature-sensitive phosphorescent particles are excited by a 385-nm ultraviolet (UV) light-emitting diode (LED) light source. Following the cessation of the UV light, multiple consecutive images of the temperature-sensitive phosphorescent particles are immediately captured using a camera to record the imaging intensities at different time points. A phosphorescence decay constant at that temperature is subsequently calculated via a phosphorescence decay equation. The temperature of the constant-temperature chamber is raised to other distinct preset temperatures. Using the same method, the corresponding phosphorescence decay constants at these different temperatures are obtained. Subsequently, the lifetime-temperature curve is established based on a variation pattern of the phosphorescence decay constants as a function of temperature. The lifetime-temperature curve is shown in FIG. 2.

It is to be noted that the phosphorescence decay constant at each temperature is determined multiple times. The mean value of these multiple phosphorescence decay constants is taken as the final phosphorescence decay constant for that temperature. The temperature-sensitive phosphorescent particles used in this embodiment are Mg₄FGeO₆:Mn⁴⁺. The particles have a median particle size (D50) of 6.5±1.5 μm and a particle concentration of 2.87×10⁵ particles per milliliter.

In step 200, time-sequential images of the temperature-sensitive phosphorescent particles are captured under illumination.

Specifically, the temperature-sensitive phosphorescent particles are illuminated by a high-power white LED or a halogen light source, and trichromatic-mask time-sequential color images of the particles are captured using a trichromatic-mask single-color camera.

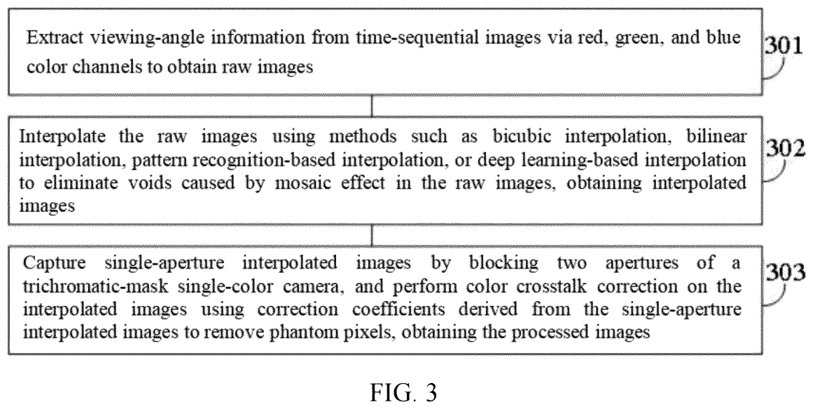

In step 300, the time-sequential images are processed via three-view separation to obtain processed images. The specific steps of which are shown in FIG. 3 and include:

In step 301, raw images are extracted from three distinct viewing angles of the time-sequential images through red, green, and blue color channels.

In step 302, the raw images are interpolated using methods such as bicubic interpolation, bilinear interpolation, pattern recognition-based interpolation, or deep learning-based interpolation to eliminate voids caused by the mosaic effect in the raw images, thereby obtaining interpolated images.

In step 303, single-aperture interpolated images are captured by blocking two apertures of the trichromatic-mask single-color camera, and color crosstalk correction is performed on the interpolated images using correction coefficients derived from the single-aperture interpolated images to remove ghost pixels, thereby obtaining the processed images.

Specifically, the time-sequential images being processed via three-view separation to obtain processed images further includes the following steps: volume calibration is performed on the interpolated images to obtain a transformation relationship between 2D image coordinates and 3D world coordinates.

Specifically, in this embodiment, volume calibration is performed using a planar calibration plate. The 2D positional information of the planar calibration plate is known. By vertically moving the calibration plate along the depth direction, its 2D information at different depth positions is acquired. The 3D positions of the calibration plate are determined based on all the known 2D information and the corresponding depth positions. The transformation relationship between 2D image coordinates and 3D world coordinates is expressed as follows:

$$[ \begin{matrix}{x}_{j} \\ {y}_{j} \\ 1\end{matrix} ] = [ \begin{matrix}{a}_{11} {a}_{12} {a}_{13} {a}_{14} \\ {a}_{21} {a}_{22} {a}_{23} {a}_{24} \\ {a}_{31} {a}_{32} {a}_{33} {a}_{34}\end{matrix} ] \cdot [ \begin{matrix}{X}_{j} \\ {Y}_{j} \\ {Z}_{j} \\ 1\end{matrix} ] ,$$

where xⱼ and yⱼ represent horizontal and vertical coordinates in an image coordinate system, respectively; Xⱼ, Yⱼ, and Zⱼ are 3D coordinates in a world coordinate system; and a₁₁, a₁₂, . . . , and a₃₄ are coefficients constituting a matrix. These coefficients are determined through a calibration process and include the camera's intrinsic parameters (such as focal length and principal point coordinates) and extrinsic parameters (such as the camera's position and orientation).

In step 400, 3D reconstruction and trajectory fitting are performed on the processed images to obtain a 3D velocity field.

Specifically, 2D particle pixel coordinates in the first four frames of processed images are identified, and a 3D particle distribution is calculated via triangulation. The known particles' 2D projections are removed from the first four frames based on the obtained 3D distribution. A new 3D particle distribution is recalculated from these subtracted images. This iterative process is repeated until the 3D positions of all particles are acquired.

Subsequently, based on the 3D particle distribution, the particle positions in the subsequent frames (after the first four) are predicted using a Wiener filter. The prediction results are compared with the actual positions acquired by the camera, and particle trajectories are obtained through jitter adjustment.

The 3D velocity field is derived from the 3D distribution of the particle trajectories.

More specifically, the jitter adjustment is performed by shifting the 3D world coordinates (x, y, z) of the prediction result by ±1 unit along each axis. A residual-displacement relationship curve is fitted from residuals between reprojection images of the shifted coordinates and the processed images. The coordinates corresponding to the minimum residual on the curve are identified as the correct 3D world coordinates. Based on these correct coordinates, the particle positions are re-predicted to obtain the particle trajectories.

In step 500, red full-resolution images of the temperature-sensitive phosphorescent particles are acquired following the illumination.

Specifically, the high-power white LED or halogen light source is turned off. The temperature-sensitive phosphorescent particles are immediately illuminated with 385-nm pulsed light. Following the illumination, a sequence of trichromatic-mask color images capturing the decay of the initial phosphorescence intensity from high to low is acquired by the trichromatic-mask single-color camera. Red full-resolution images are extracted from the red channel of the trichromatic-mask color images. The red full-resolution images contain the phosphorescence intensity information of the temperature-sensitive phosphorescent particles.

In step 600, intensities of the temperature-sensitive phosphorescent particles from the red full-resolution images are calculated, and a phosphorescence lifetime is determined based on the intensities of the particles.

Specifically, 2D particle positions in the red full-resolution images are tracked, guided by the 3D velocity field, to determine the corresponding 3D spatial distribution. Based on the phosphorescence decay equation, a decay constant is derived from the particle distribution and the intensities of individual particles at different time points in the trichromatic-mask color images. This decay constant serves as the phosphorescence lifetime.

In step 700, a 3D temperature field is determined based on the lifetime-temperature curve and the phosphorescence lifetime.

A 3D temperature field is constructed by referencing the lifetime-temperature curve to map the distribution of phosphorescence lifetime values to the corresponding temperature distribution.

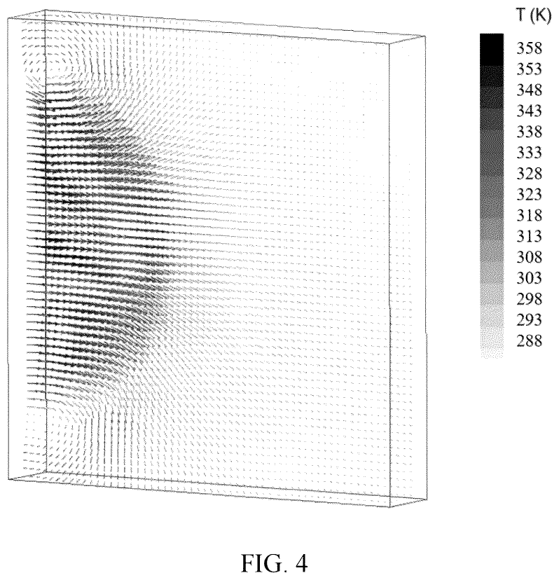

In step 800, the 3D velocity field and the 3D temperature field are fused to obtain a 3D velocity-temperature field. The 3D velocity-temperature field of this embodiment is shown in FIG. 4.

The present disclosure has the following beneficial effects.
1. The image resolution is improved by the three-view separation technique using a trichromatic-mask single-color camera.
2. The accuracy of the construction process is enhanced by building a 3D velocity field through 3D reconstruction and jitter adjustment.
3. The stability of the acquisition process and the precision of temperature measurement are increased by obtaining the 3D temperature field using the lifetime-temperature curve of temperature-sensitive phosphorescent particles.

In the specification, the embodiments are described in progressive order. Each embodiment primarily emphasizes distinctions from other embodiments, while identical or similar aspects across embodiments may be cross-referenced.

In the present disclosure, the specific examples are applied to explain the principles and implementations of the present disclosure, and the above embodiments are illustrated only to assist in understanding the methods and core ideas of the present disclosure. Meanwhile, for those ordinary skilled in the art, the specific implementations and the applied range may be changed according to the ideas of the present disclosure. In conclusion, the contents of the specification are not to be construed as a limitation to the present disclosure.

1. A method for simultaneous measurement of velocity and temperature fields based on temperature-sensitive phosphorescent particles, comprising the steps of:
establishing a lifetime-temperature curve by measuring lifetimes of the temperature-sensitive phosphorescent particles,
capturing time-sequential images of the temperature-sensitive phosphorescent particles under illumination,
processing the time-sequential images via three-view separation to obtain processed images,
performing three-dimensional (3D) reconstruction and trajectory fitting on the processed images to obtain a 3D velocity field,
acquiring red full-resolution images of the temperature-sensitive phosphorescent particles following the illumination,
calculating intensities of the temperature-sensitive phosphorescent particles from the red full-resolution images, and determining a phosphorescence lifetime based on the intensities of the particles,
determining a 3D temperature field based on the lifetime-temperature curve and the phosphorescence lifetime, and
fusing the 3D velocity field and the 3D temperature field to obtain a 3D velocity-temperature field, wherein
the performing 3D reconstruction and trajectory fitting on the processed images to obtain a 3D velocity field comprises the steps of:
obtaining a 3D particle distribution of a first portion of the processed images via triangulation;
performing a particle position prediction on a second portion of the processed images using the 3D particle distribution and a Wiener filter, to obtain a prediction result;
performing a coordinate shift on 3D world coordinates of the prediction result to obtain shifted coordinates;
obtaining a residual-displacement relationship curve from residuals between reprojection images of the shifted coordinates and the processed images;
re-predicting particle positions by applying the residual-displacement relationship curve to the prediction result to obtain particle trajectories; and
deriving the 3D velocity field from a 3D distribution of the particle trajectories; and
the calculating intensities of the temperature-sensitive phosphorescent particles from the red full-resolution images, and determining a phosphorescence lifetime based on the intensities of the particles comprise the steps of:
performing two-dimensional (2D) particle tracking on the red full-resolution images using the 3D velocity field to obtain a red particle distribution; and
calculating the phosphorescence lifetime from the red particle distribution and a phosphorescence decay equation.

2. The method for simultaneous measurement of velocity and temperature fields based on temperature-sensitive phosphorescent particles according to claim 1,
wherein the establishing a lifetime-temperature curve by measuring lifetimes of the temperature-sensitive phosphorescent particles comprises the steps of: determining phosphorescence decay constants of the temperature-sensitive phosphorescent particles at different temperatures according to the phosphorescence decay equation, and establishing the lifetime-temperature curve based on a variation pattern of the decay constants as a function of temperature.

3. The method for simultaneous measurement of velocity and temperature fields based on temperature-sensitive phosphorescent particles according to claim 1, wherein the processing the time-sequential images via three-view separation to obtain processed images comprises the steps of:
extracting viewing-angle information from the time-sequential images via red, green, and blue color channels to obtain raw images;
interpolating the raw images to obtain interpolated images; and
correcting color crosstalk in the interpolated images to obtain the processed images.

4. The method for simultaneous measurement of velocity and temperature fields based on temperature-sensitive phosphorescent particles according to claim 3, wherein the processing the time-sequential images via three-view separation to obtain processed images further comprises the steps of: performing volume calibration on the interpolated images to obtain a transformation relationship between 2D image coordinates and 3D world coordinates, with the transformation relationship expressed as:
$$[ \begin{matrix}{x}_{j} \\ {y}_{j} \\ 1\end{matrix} ] = [ \begin{matrix}{a}_{11} {a}_{12} {a}_{13} {a}_{14} \\ {a}_{21} {a}_{22} {a}_{23} {a}_{24} \\ {a}_{31} {a}_{32} {a}_{33} {a}_{34}\end{matrix} ] \cdot [ \begin{matrix}{X}_{j} \\ {Y}_{j} \\ {Z}_{j} \\ 1\end{matrix} ] ,$$
where xⱼ and yⱼ represent horizontal and vertical coordinates in an image coordinate system, respectively; Xⱼ, Yⱼ, and Zⱼ are 3D coordinates in a world coordinate system; and a₁₁, a₁₂, . . . , and a₃₄ are coefficients constituting a matrix.
